(19) United States
(12) Patent Application Publication
(10) Pub. No.: US 2007/0021995 A1
(43) Pub. Date: Jan. 25, 2007

(54) Discovering patterns of executions in business processes

(76) Inventors: Candemir Toklu, Nutley, NJ (US); Benoit Dubouloz, Geneva (CH)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/443,863

(22) Filed: May 31, 2006

Related U.S. Application Data
(60) Provisional application No. 60/701,105, filed on Jul. 20, 2005.

(51) Int. Cl. G06F 9/44

(52) U.S. Cl. 705/7

(57) ABSTRACT

A computer-implemented method for analyzing business processes described in a business process execution language includes mapping a workflow abstract model graph from each of a plurality of business process descriptions corresponding to the business processes, identifying message exchange patterns between the business processes, and merging the workflow abstract model graphs into a common graph without connections between nodes associated with the plurality of business processes descriptions. The computer-implemented method further includes adding arcs between nodes of the different business processes descriptions within the common graph according to a merging rule and the message exchange patterns, and mining the common graph for a frequency of path execution, wherein a path is a set of nodes connected by the arcs.

### CROSS-REFERENCE TO RELATED APPLICATIONS

This application claims the benefit of Provisional Application No. 60/701,105 filed on Jul. 21, 2005 in the United States Patent and Trademark Office, the contents of which are herein incorporated by reference in its entirety.

### BACKGROUND OF THE INVENTION

1. Technical Field

The present disclosure relates to business process management, and more particularly to a system and method for determining patterns of executions in business processes.

2. Description of Related Art

Business Process Management System (BPMS) empower companies with complete solutions for process management. They provide the capability to manage the complete lifecycle of processes, to discover, design, deploy, execute, interact with, operate, optimize and analyze end to end processes, and finally to do it at the level of business design, not technical implementation. Business process management includes mapping processes and designing improvements based on collected process performance data. Exemplary process improvement methodologies include Six Sigma, TQM, QFD, QS9000, ISO9000, etc.

Web services have emerged as a powerful abstraction of the application component interface and business service definition. Web services are posed to become a preferred service oriented architecture for exposing application capabilities as reusable services and structuring service directories and repositories. Service Oriented Architecture (SOA) is gaining momentum for the definition of information systems. Supported by the Web Services Stack, SOA enables the organization of information systems as connected systems and building enterprise applications as composite applications that can be create easily and changed as needed. To get the full value of web services built on top of SOA, the emerging BPMS's provide process engines to orchestrate them in support of the needs of the customer.

Business Process Execution Language for Web Services (BPEL4WS or BPEL in short) is an XML based description to enable web services composition. It allows the definition of complex processes using web services invocation as basic activities. Process access is exposed as standard web services.

BPMS vendors have built graphical tools for designing business processes in BPEL. When the process description is deployed in a BPMS, instances are created on demand and all the activities and communications are logged. These logs can then become the basis for process analysis and optimization.

Therefore, a need exists for a system and method of finding a most executed sequence of activities or patterns of executions for process analysis.

### SUMMARY OF THE INVENTION

According to an embodiment of the present disclosure, a computer-implemented method for analyzing business processes described in a business process execution language includes mapping a workflow abstract model graph from each of a plurality of business process descriptions corresponding to the business processes, identifying message exchange patterns between the business processes, and merging the workflow abstract model graphs into a common graph without connections between nodes associated with the plurality of business processes descriptions. The computer-implemented method further includes adding arcs between nodes of the different business processes descriptions within the common graph according to a merging rule and the message exchange patterns, and mining the common graph for a frequency of path execution, wherein a path is a set of nodes connected by the arcs.

According to an embodiment of the present disclosure,

a computer implemented method may be implemented by a program storage device readable by machine, tangibly embodying a program of instructions executable by the machine to perform method steps for analyzing business processes described in a business process execution language.

According to an embodiment of the present disclosure, a computer-system for analyzing business processes described in a business process execution language includes a business process description database on a plurality of business process descriptions,-an instance log database on a plurality of instance logs for each of the plurality of business process descriptions, a merging tool coupled to the business process description database for assembling the business process descriptions into a common process description, a mapping tool for mapping paths of the common description, and a workflow mining tool coupled to the instance log database for determining frequencies of path execution according to the instance logs, wherein the mapping tool generates a graphical visualization of the common process description and frequencies of path execution.

### BRIEF DESCRIPTION OF THE DRAWINGS

Preferred embodiments of the present invention will be described below in more detail, with reference to the accompanying drawings:

FIG. 1 is an exemplary mapping of BREL to WAM according to an embodiment of the present disclosure;

FIG. 2 is an exemplary adjency matrix construction according to an embodiment of the present disclosure;

FIGS. 3A-B are illustrations of a pick construct and a receive construct, respectively according to an embodiment of the present disclosure;

FIGS. 4A-C is an illustration of two loop semantics according to an embodiment of the present disclosure;

FIG. 5 is an illustration of EW-patterns generated during an initialization phase according to an embodiment of the present disclosure;

FIGS. 6A-B are experimental results for an executed path for 9/11 and an annotated process schema, respectively according to an embodiment of the present disclosure;

FIG. 7 illustrates a BPEL message exchange patterns according to an embodiment of the present disclosure;

FIG. 8 is an illustration of tree and directed acyclic graphs according to an embodiment of the present disclosure;

FIG. 9A is a diagram of a high-level framework structure according to an embodiment of the present disclosure;

FIG. 9B is a flow chart of a method according to an embodiment of the present disclosure; and

FIG. 10 is a diagram of a computer system according to an embodiment of the present disclosure.

### DETAILED DESCRIPTION OF PREFERRED EMBODIMENTS

According to an embodiment of the present disclosure, a framework is implemented on top of a pattern mining method to support BPEL functionalities. The framework provides a process designer with information for identifying redundant, duplicate, and unused steps by providing frequent sub patterns, frequent paths from start to end, frequent scheduled process substructures containing a given activity, and frequent path from start to end containing a given activity. The framework also provides activity based frequent sub patterns, frequent scheduled process substructure containing a given activity, and multiple processes frequent sub patterns mining

In a production environment multiple BPEL processes interact. The BPEL processes may be designed independently and may be deployed on different BPEL engines. The framework merges representations of each BPEL process into one common graph and collects logs of the BPEL processes to find frequencies of pattern execution in the merged representation of the processes. The common graph representation may be used to assess an overall process protocol and help detecting inconsistencies in the overall process. For example, after having merged the graphs it may be possible that some processes may induce inconsistent cycle in the overall process. These inconsistent cycles may be detected using polynomial time algorithms on the generated graph.

The framework is based on workflow schema as is a starting point for determining performance data. In addition, the framework may be used to find patterns and paths that are never or rarely executed. Finding non-executed patterns or paths could help the process designer to optimize a process.

According to an embodiment of the present disclosure, an extension to the framework for single BPEL process mining enables the mining of frequent pattern of execution across multiple interacting BPEL processes.

The framework is implemented for mining graphs with constraints imposed by the structures of workflow schemes and instances. The workflow execution logs are analyzed contextually and comparatively on the basis of the process map to find frequent patterns of activities, thus discovering useful knowledge. Various mining methods may be implemented within the framework.

Process mining refers to the analysis of execution logs to find frequent patterns and paths of executions. A prototype implementation has been tested in real world situations where all the execution logs come from a running BPEL engine. The prototype implemented, and therefore the framework, can be extended to handle other workflow description languages, including XPDL, etc., and be integrated to other production environments utilizing process engines.

A control flow graph model is used as a basis for determining a graph. The model, named as Workflow Abstract Model (WAM), does not incorporate compensation and assumes non-iterative executions. WAM aims at providing a rigorous framework on top of which the mining method may be developed.

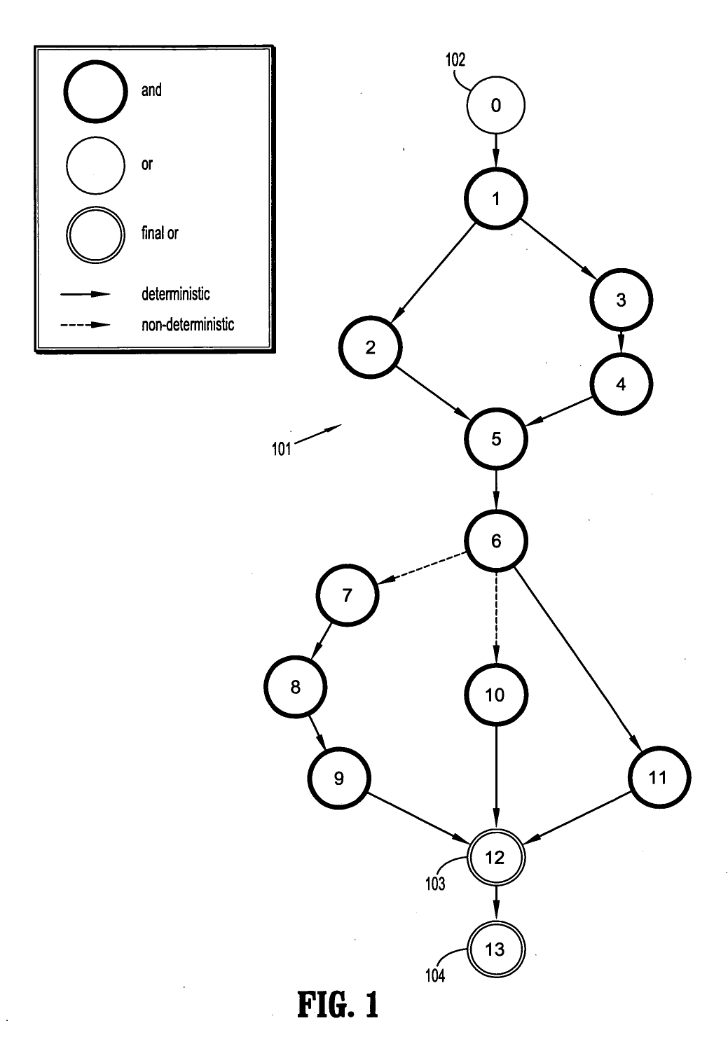

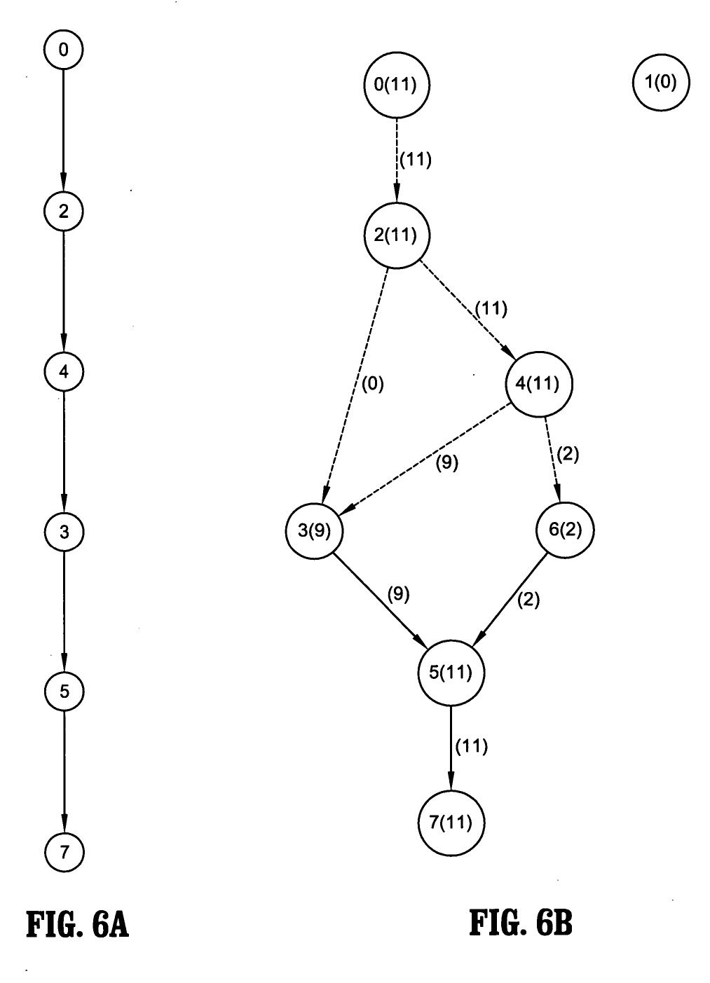

A WAM graph, such as that shown in FIG. 1, is a tuple composed of a finite set of activities 101, an acyclic relation of precedence among activities, e.g., deterministic or non-deterministic, a start activity 102 and a set of final activities 103-104. Each activity is assigned one of 3 natural number values, IN, OUTmin, and OUTmax, referring to the number of incoming links, the minimum number of outgoing links and maximum number of outgoing links, respectively. Activities 101 are classified in two categories, and-join that can be executed only after all its predecessors are completed and or-join that can be executed as soon as one predecessor is completed. Arcs are labeled in three ways depending whether the source node is a full fork, a deterministic fork or an exclusive fork. FIG. 6B shows the graph representation in the WAM of the BPEL process described in FIG. 6A.

Methods such as W-find are available for BPEL to WAM mapping. W-find relies on a notion of elementary weak pattern, pattern of activities that are enforced to be executed with some activity. An elementary week pattern or ew-pattern, is the graph ws-closure (<{a},{ }>). Where a ws-closure is defined as a graph where every and-join node must contain all its parents and every node that is a deterministic fork must contain all its or-join childrens.

Initialization constructs the set of elementary weak patterns and the set of frequent arcs from the instances log. Each process instance log is represented as a WAM graph. The mapping method then iterates through all frequent elementary weak patterns and tries to add frequent arcs and frequent elementary weak patterns to each elementary weak pattern of the initial set.

By transforming the BPEL process description and the BPEL logs according to the WAM, the mapping method may be used on BPEL described processes. The BPEL process description file is used to derive the WAM graph of the process from which the ew-patterns are generated. The process instance logs are also transformed into WAM graphs before being sent to the mining method as input.

According to an embodiment of the present disclosure, only a subset of the BPEL elements are represented in the WAM model. Structured elements like flows, scope, and while are not represented since the semantic of their construct can be expressed by the link type and node type of the WAM. This reduces the number of operations and data size for the mapping method and makes the needed log information smaller and inter-operable with log data gathered by capturing message exchanges on the network. FIG. 6B shows the mapping of the BPEL process described on FIG. 6A to the WAM model. FIG. 1 is an example of BPEL to WAM mapping. Table 1 is an excerpt from the example process described in BPEL.

TABLE 1

```
  1  <process>
  2  <sequence>
  3  <receive name=“ReceiveCustomercontact”
createInstance=“yes”/>
  4  <flow name=“prepareThread”>
  5  <invoke name=“SelectSupportexpert”/>
  6  <sequence name=“assignAndAcknowledge”>
  7  <invoke name=“AssignTicketID”/>
  8  <invoke name=“Acknowledgereception”/>
  9  </sequence>
10  </flow>
11  <invoke name=“Requestdataclarification”/>
12  <receive name=“Receivedataclarification”/>
13  <flow>
14  <switch name=“contactClarified”>
15  <case condition=“contactAccepted=true”>
16  <sequence>
17  <invoke
name=“SelectSupportAgent”/>
18  <invoke name=“Execute”/>
19  <receive
name=“receiveExecution”/>
20  </sequence>
21  </case>
22  <otherwise>
23  <invoke
name=“InformCustomerofrejection”/>
24  </otherwise>
25  </switch>
26  <invoke name=“LogClarification”/>
27  </flow>
28  <invoke name=“InformCustomerofrejection”/>
29  </sequence>
30  </process>
```

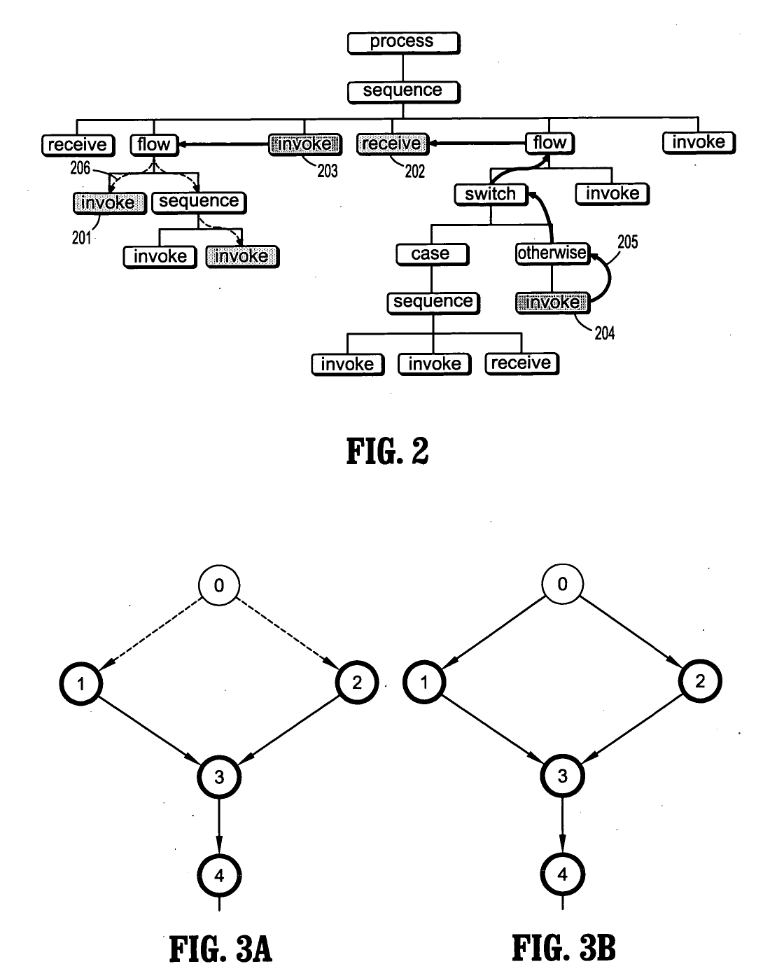

Due to its origin in two different workflow languages, BPEL inherited a block structure process representation from XLANG and a graph-oriented representation from WSFL. The WAM is a Directed Acyclic Graph (DAG). The mapping method input data structure includes two matrixes for the workflow schema: a matrix of arcs or the adjency matrix, defining the precedence relation between nodes, and a matrix of nodes including the nodes of the WAM. Each instance log is also represented as a graph with the matrix of arcs and the matrix of nodes. The matrix of nodes is constructed by extracting the nodes that constitute a basic activity. BPEL actions including assign, invoke, receive, reply, empty, terminate, onAlarm, onEvent and while are represented as nodes in the WAM graph. The precedence relationships between nodes are discovered by a method illustrated in FIG. 2.

The notion of precedence between nodes is found with a recursive algorithm determining the predecessors and the type of the relation for a given node. Referring to FIG. 2, the method includes determining the predecessors from the block structure of BPEL and the determining the predecessors from the directed graph structure. An example of the predecessor determination for the block structure is shown in FIG. 2 as an adjency matrix construction. Nodes 201 and 202 are predecessors of the nodes 203 and 204. The solid arrows 205 represent a find preceding method, in this case receive 202, and the dashed arrows 206 the find preceding in, in this case invoke 201.

Without modifying the semantic of the graphed process, an artificial start and end node are added to the graph after the mapping. In BPEL, multiple start activities are allowed to express the possibility that any one of a set of inbound messages can create the process instance because the order in which these messages arrive cannot be predicted. The start activities that have not been selected as the one creating the instance will still wait for incoming messages and will be executed in the already created process instance. If one is interested in expressing that a process can be started by only one of a set of activities prohibiting the further execution of other concurrent start activities, the BPEL pick construct can be used. The artificial start activity will have different links depending on the type of start activity and those start activities may be of a different type if they are concurrent receive activities or message events of a pick activity. This is illustrated in FIGS. 3A-B. The end activities are also taken care of since not all BPEL end activities may need to be executed in a process where switch constructs appears. Thus, deciding if the type of the link between the end activities and the artificially added end activity will depend on the presence of choices in the parent activities of the treated end activity. FIGS. 3A-B illustrate multiple starts, including pick (FIG. 3A) and receive constructs (FIG. 3B).

The while element is an interesting construct since it is a factor in the process variability. The mining of loops can be classified into different categories. In a first analysis of loops, one could be interested in the graphical perspective only and look at the most executed path followed in the loop body independently of the number of iteration. Another way to look at loops would be to consider only the path generated at the end of the loop execution. A third and fourth way to consider loops is an extension of the two identified case where loops are first differentiated by the number of iteration and by discriminating either by the frequent paths or the graphical perspective.

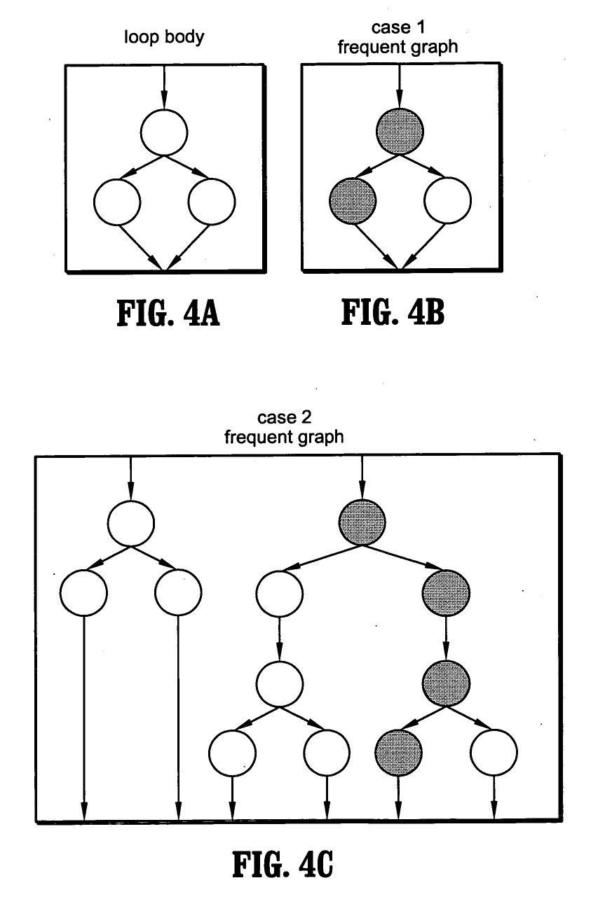

FIG. 4A is an illustration of a loop bode. FIGS. 4B-C illustrate graph and path generation perspectives, respectively, as a two loop semantic.

Graph perspectives are supported by defining the while constructs as node of a main process graph and considering each loop's iteration as instances of a process defined by the loop body (e.g., see FIG. 4A). The graphical perspective (FIG. 4B) is determined by mining the process defined by the loop body with the instances being the loop iteration. The framework may be expanded to find loops having a path generated most frequently in the overall loop execution (e.g., see FIG. 4C).

The graphical representation of loops is of interest here, and thus represents the while, onAlarm and onEvent inside an event handler as a node in the WAM graph. If this node is handled frequently, the loop body is mined for frequent graphical paths. For analysis, the frequent loop body may be substituted to the loop body in the final graph result. The event handling is implemented the same way as loops. In this case, events are treated as loop iteration.

Error and compensation handling add variability to the process. In the mapping, error and compensation are handled by adding the possible arcs and nodes they may generate to the WAM. Each BPEL element represented in the WAM graph may generate an error and thus has an outgoing link to the error handler or a process terminator. The result is that the solid links in the WAM graph may be removed. Indeed a next step of an activity can be either the activity defined by the control flow or the error handling activity. Compensation handlers are added to the WAM graph as a possible continuation of the scope or activity they are associated with.

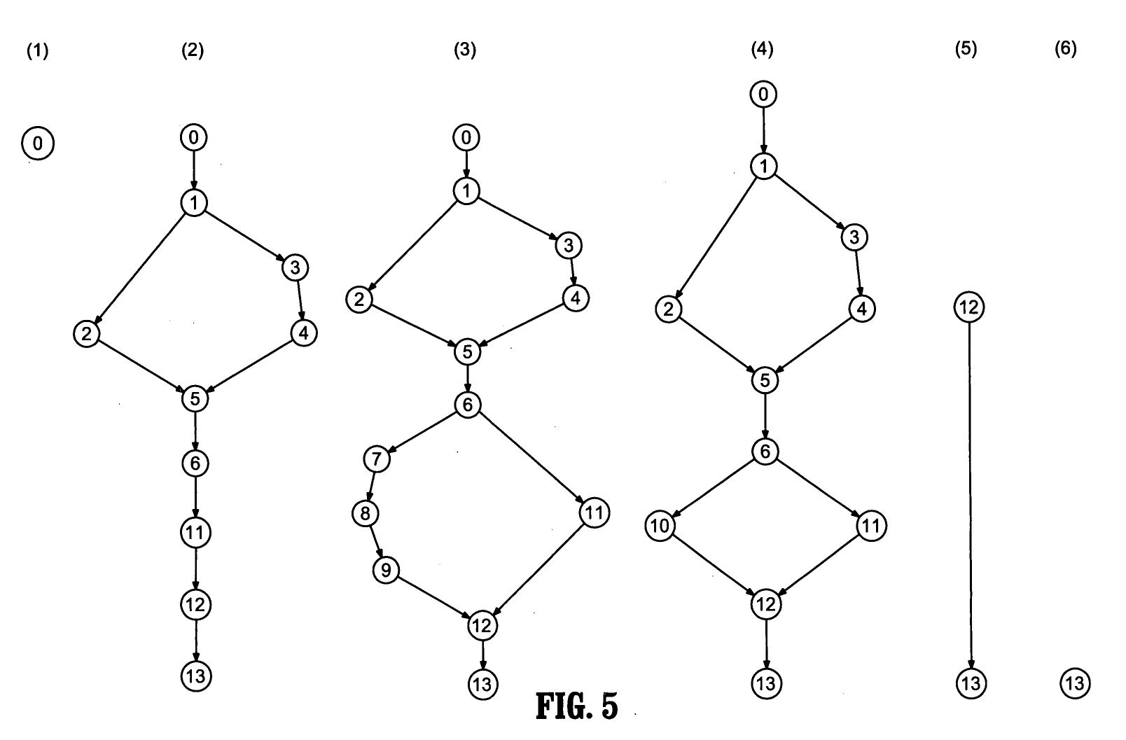

Optimization can be done by reducing the number of weak patterns the mapping generates in the initialization. The number of ew-patterns can be pruned, taking into account the restriction imposed by the BPEL process structure. Not all BPEL constraints can be made explicitly in the WAM. Pruning prohibited elementary weak patterns reduces the computation resources needed and data input size. In the example of activity precedence being described by BPEL links, advantage can be taken by restricting the ew-patterns to the set of all possible combinations of the allowed transition and join condition, see for example, FIG. 5.

FIG. 5 illustrates EW-patterns generated during the initialization of the framework applied to mining the process shown in FIG. 1. Ew-pattern 2 (0,1,2-3,4,5,6,11,12,13) can be removed from the set of ew-patterns since it is prohibited by the BPEL process description that states that node 11 needs to appear in the process.

The mining framework, including a mapping method, has been tested against processes running on a BPEL 1.1 compliant process engine. ActiveBPEL process engine is an open-source and powerful BPEL engine. It provides a SOAP (Simple Object Access Protocol) API (Application Programming Interface) to access the engine functions and a graphical administrative web front-end enabling the visualization of process instances.

The input for the framework, the BPEL process description and the execution logs, are gathered through ActiveBPEL SOAP API. For mining the process deployed in the ActiveBPEL engine, the logs produced by the engine had to be mapped to a suitable format. The ActiveBPEL logs are converted using the same steps as for the transformation of BPEL process definition into WAM graphs.

The framework has been applied to the loan approval process to find a most frequent pattern and path of execution. FIG. 6B shows the most executed path for a minimum support of 9/11, whereas FIG. 6B shows the annotated WAM graph after the mining. In these figures each circle denotes an activity in the process, and the number inside the circle denotes the activity number. Each number within the parenthesis inside each circle in FIG. 6B corresponds to the number of executions of the given arcs and nodes. For example, out of 11 executions of the process 9 went through the approver activity (activity #3).

In a production environment multiple independent BPEL processes will be interacting. Being able to merge the representations of each process into one common graph and collecting the correspond logs to find frequencies of pattern execution in the overall process allows process optimization.

FIGS. 6A-B show experiment results, wherein FIG. 6A is an executed path for support 9/11 and FIG. 6B is an annotated process schema.

Communications with partners are exposed by BPEL processes as web service operations. Thus, BPEL processes partners can be any software that provides a needed set of web service operations and conform to an expected interface. They can be stateless web services, other BPEL processes, or any other type of processes or software using web services for external communications. BPEL processes are linked to their partner processes by the mean of partner links and roles. A partner link defines the agreement between to parties on their respective roles and roles define the set of WSDL (Web Service Description Language) operations that a partner needs to provide. Each process definition specifies which role it plays in the partnership. In BPEL four activities can be used to exchange messages with partners. They rely on the WSDL notion of operation and portType. Each activity exchanging messages with partners is implicitly associated with is partner link attribute to a WSDL port type and needs to specify exactly one WSDL target operation. Operations in WSDL are defined by the type of message sent and accepted. An operation is identified by the ordered combination of input and output messages. These may include:
one-way reception—input message type specified;
request response—input and output message specified;
solicit response—output and input message specified; and
notification—output message specified.

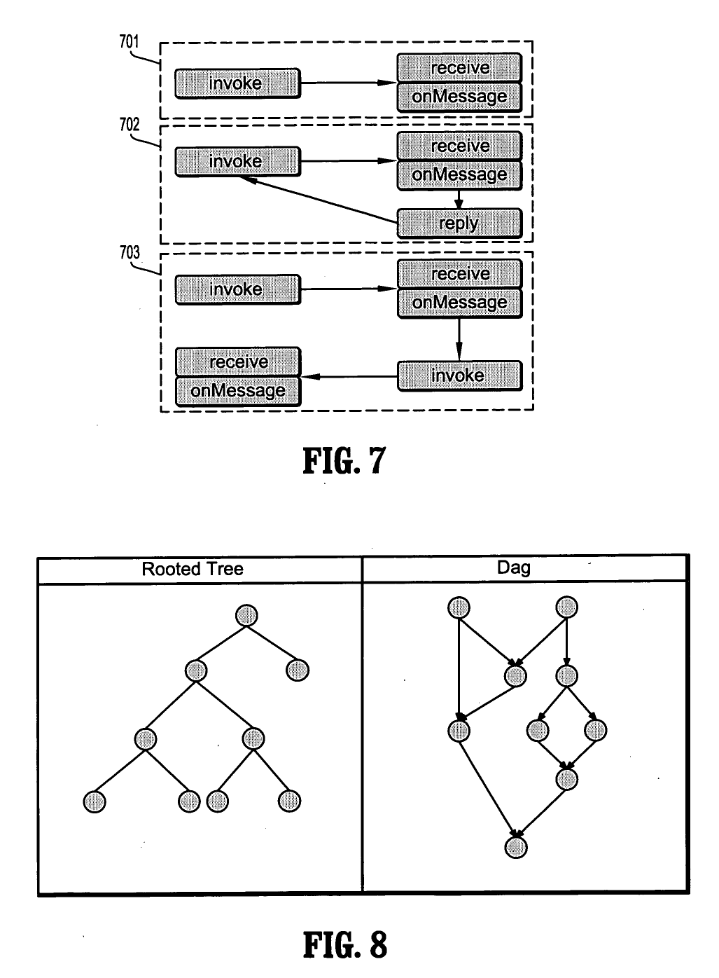

Thus, BPEL process messaging capabilities rely on the four basic WSDL patterns of operation and provide four activities that enable message exchange. The four patterns include invoke, reply, receive, and onMessage. FIG. 7 illustrates various BPEL message exchange patterns.

Invoke is a call for a web service operation in a synchronous or asynchronous manner. If the call is asynchronous the activity doesn't wait for an answer. If the call is synchronous, the activity block until reception of the partner's response. Reply sends the synchronous response to a previously received message. Receive acknowledges reception of a message. If there is no reply associated with the receive activity it is said to be asynchronous otherwise it is synchronous. onMessage acknowledges reception of a message. If there is no reply associated with the onMessage activity it is said to be asynchronous otherwise it is synchronous.

The combination the messaging primitives enables three different message exchange patterns. The graphical representation of message exchange patterns is showed on FIGS. 6A-B. FIG. 6A represents a process while FIG. 6B represents its partner for the current message exchange.

Referring to FIG. 7, in one way messaging a message is sent to another without relation to a prior or a posterior message exchange 701. The other process waits for a message without relation to another message. Synchronous messaging, a process sends a message to a partner and block until reception of a response from this partner 702. For asynchronous messaging, a process sends a message to a partner continues his processing and later on block until reception of a message related to the first message 703.

Directed Acyclic Graphs (DAG) are graphs where every edge has a direction and no path starts and ends at the same vertex. DAGs are well-known in computer science, for example in code optimization when building Program Dependence Graphs (PDG), computing dependencies in basic blocks thus enabling common sub expression elimination and dead code elimination, in compilation to build parse tree and in fields like decision support systems and knowledge modeling where Bayesian Network are used. FIG. 8 is an illustration of tree and directed acyclic graphs.

Due to its origin in the merging of two different WSCLs, BPEL supports a hybrid model providing block structured graph maps and control flow graph representation. Without considering the repeatable activities, namely loops and event handlers, the block structure prohibits cycles from appearing in the graph. Namely each block is contained in another block thus forming a rooted tree structure. Since rooted trees are special kind directed acyclic the block structure of BPEL processes will describe a DAG. As for the flow structure, it is used when defining control flow between activities inside a flow element. The specification states that:
A link MUST NOT cross the boundary of a while activity, a serializable scope, an event handler, and a compensation handler [. . .] Finally, a link MUST NOT create a control cycle [. . .] Therefore, directed graphs created by links are always acyclic.

For mining BPEL processes, repeatable structures are handled like while and event handlers by representing them as a sub process. The body of repeatable structures is consequently not represented in the common graph but processed as an independent graph. The results are merged after processing to the common graph. This representation enables a DAG representation of a BPEL process, which can be mined by the framework.

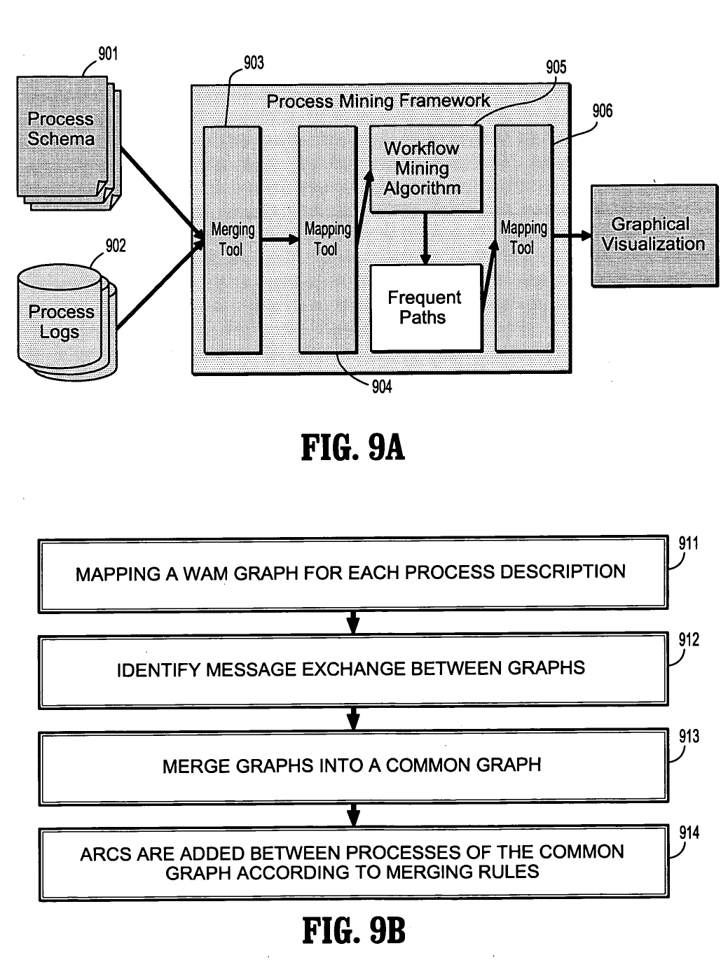

According to an embodiment of the present disclosure, a method for process mining works much the same way for mining multiple BPEL processes or a single BPEL process. The difference lies in the preparatory steps. Referring to FIG. 9A, from an outside view, the input of the method includes multiple BPEL processes 901 and multiple instance logs 902 for each of these processes. The process descriptions are assembled into a common process description and logs are merged accordingly to the common process description using a merging tool 903. The common description and logs are processed by a mapping tool 904, a workflow mining tool 905 (e.g., a BPEL process mining), which determines path frequencies, and a mapping tool 906 for generating a graphical visualization. Merging tools 904 and 906 may be the same or different tools.

Referring to FIG. 9B, according to an embodiment of the present disclosure, the method executes as described in table 2. The WAM graph is generated for each process description 911. The message exchange patterns between processes are identified 912. The BPEL descriptions are merged into one graph but without connection between the processes 913. Arcs are added between the processes according to the merging rules 914 defined in table 3.
Generation of the independent WAM graphs
Identification of the message exchange patterns
Construction of one common graph without connections
Linking between graphs according to the rules defined on the message exchange patterns
Table 2. Multiple BPEL merging steps.

The Merging rules for multiple interacting BPEL processes are illustrated in Table 3.
Asynchronous message exchange
   An arc is added between the invoker and the receiver
Synchronous message exchange
   Addition of an arc between the invoker and the receive activity
   Creation of an extra node for reception of the message at the invoker side
   Addition of an arc between the reply activity and the invoker extra node
   Addition of an arc between the invoker and the invoker extra node
   Table 3

One of ordinary skill in the art would appreciate that other merging rules may be implemented.

Workflow mining methods are extended to support the mining of BPEL processes.

Error handling and compensation constructs of BPEL may be implemented. The XML workflow log format may be supported. Having a standard log format would enable easier integration of the framework with different BPEL engines for which a translation to this format is already available.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

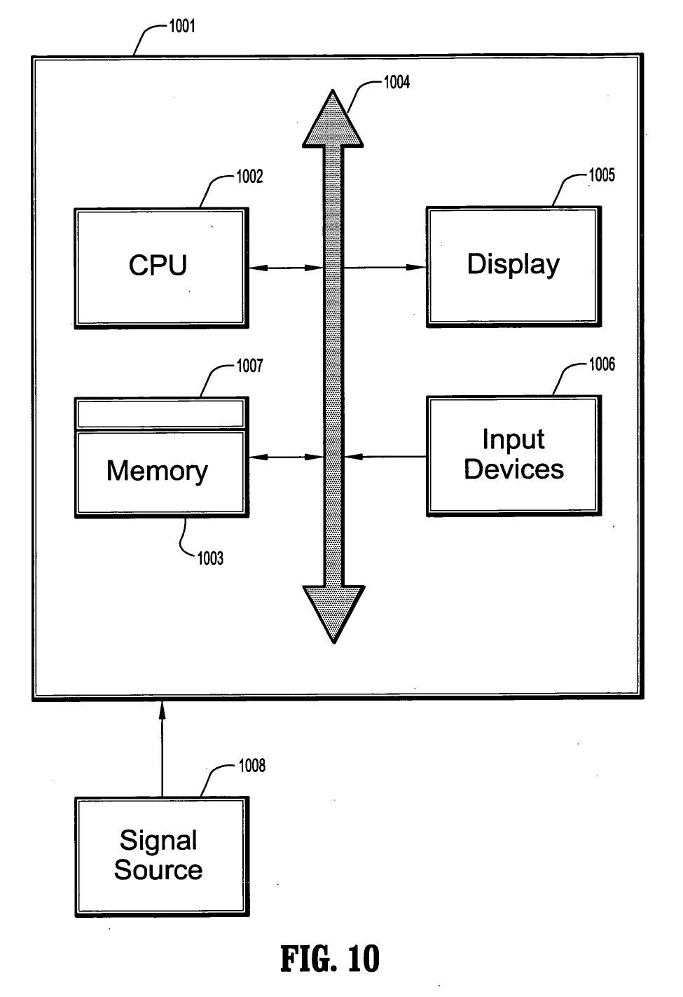

Referring to FIG. 10, according to an embodiment of the present disclosure, a computer system 1001 for determining patterns of executions in business processes can comprise, inter alia, a central processing unit (CPU) 1002, a memory 1003 and an input/output (I/O) interface 1004. The computer system 1001 is generally coupled through the I/O interface 1004 to a display 1005 and various input devices 1006 such as a mouse and keyboard. The support circuits can include circuits such as cache, power supplies, clock circuits, and a communications bus. The memory 1003 can include random access memory (RAM), read only memory (ROM), disk drive, tape drive, etc., or a combination thereof. The present invention can be implemented as a routine 1007 that is stored in memory 1003 and executed by the CPU 1002 to process the signal from the signal source 1008. As such, the computer system 1001 is a general-purpose computer system that becomes a specific purpose computer system when executing the routine 1007 of the present invention.

The computer platform 1001 also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components, e.g., the merging tool 903, and method steps depicted in the accompanying figures may be implemented in software, the actual connections between the system components (or the process steps) may differ depending upon the manner in which the present invention is programmed. Given the teachings of the present disclosure provided herein, one of ordinary skill in the related art will be able to contemplate these and similar implementations or configurations.

Having described embodiments for a system and method for determining patterns of executions in business processes, it is noted that modifications and variations can be made by persons skilled in the art in light of the above teachings. It is therefore to be understood that changes may be made in embodiments of the present disclosure that are within the scope and spirit thereof.

What is claimed is:

1. A computer-implemented method for analyzing business processes described in a business process execution language, comprising:
mapping a workflow abstract model graph from each of a plurality of business process descriptions corresponding to the business processes;
identifying message exchange patterns between the business processes;
merging the workflow abstract model graphs into a common graph without connections between nodes associated with the plurality of business processes descriptions;
adding arcs between nodes of the different business processes descriptions within the common graph according to a merging rule and the message exchange patterns; and
mining the common graph for a frequency of path execution, wherein a path is a set of nodes connected by the arcs.

2. The computer-implemented method of claim 1, further comprising collecting execution logs of the business processes, wherein the frequency of execution is mined from the execution logs.

3. The computer-implemented method of claim 1, wherein the arcs constrain the mining to paths of the common graph.

4. The computer-implemented method of claim 1, further comprising adding artificial start and end nodes after mapping the workflow abstract model graph.

5. The computer-implemented method of claim 1, wherein merging comprises determining an asynchronous message exchange between nodes, where in an arc is added between an invoker and a receiver in the asynchronous message exchange.

6. The computer-implemented method of claim 1, wherein merging comprises determining a synchronous message exchange between nodes.

7. The computer-implemented method of claim 6, wherein determining a synchronous message exchange between nodes comprises:
adding an arc between an invoker and a receive activity;
adding a reception node for reception of the message at an invoker side of the synchronous message exchange;
adding an arc between a reply activity and the reception node; and
adding an arc between the invoker and the reception node.

8. A program storage device readable by machine, tangibly embodying a program of instructions executable by the machine to perform method steps for analyzing business processes described in a business process execution language, the method steps comprising:
mapping a workflow abstract model graph from each of a plurality of business process descriptions corresponding to the business processes;
identifying message exchange patterns between the business processes;
merging the workflow abstract model graphs into a common graph without connections between nodes associated with the plurality of business processes descriptions;
adding arcs between nodes of the different business processes descriptions within the common graph according to a merging rule and the message exchange patterns; and
mining the common graph for a frequency of path execution, wherein a path is a set of nodes connected by the arcs.

9. The method of claim 8, further comprising collecting execution logs of the business processes, wherein the frequency of execution is mined from the execution logs.

10. The method of claim 8, wherein the arcs constrain the mining to paths of the common graph.

11. The method of claim 8, further comprising adding artificial start and end nodes after mapping the workflow abstract model graph.

12. The method of claim 8, wherein merging comprises determining an asynchronous message exchange between nodes, where in an arc is added between an invoker and a receiver in the asynchronous message exchange.

13. The method of claim 8, wherein merging comprises determining a synchronous message exchange between nodes.

14. The method of claim 13, wherein determining a synchronous message exchange between nodes comprises:
adding an arc between an invoker and a receive activity;
adding a reception node for reception of the message at an invoker side of the synchronous message exchange;
adding an arc between a reply activity and the reception node; and
adding an arc between the invoker and the reception node.

15. A computer-system for analyzing business processes described in a business process execution language comprising:
a business process description database on a plurality of business process descriptions;
an instance log database on a plurality of instance logs for each of the plurality of business process descriptions;
a merging tool coupled to the business process description database for assembling the business process descriptions into a common process description;
a mapping tool for mapping paths of the common description; and
a workflow mining tool coupled to the instance log database for determining frequencies of path execution according to the instance logs, wherein the mapping tool generates a graphical visualization of the common process description and frequencies of path execution.

16. The computer-system of claim 15, wherein the merging tool assembles the instance logs into a common log according to the common process description.

17. The computer-system of claim 15, further comprising a display for displaying the graphical visualization.
